(19) United States
(12) Patent Application Publication
(10) Pub. No.: US 2024/0273028 A1
(43) Pub. Date: Aug. 15, 2024

(54) ENERGY CONSUMPTION MEASUREMENT

(71) Applicant: Intel Corporation, Santa Clara, CA (US)

(72) Inventors: Corey D. GOUGH, Portland, OR (US); Yuval BUSTAN, Moshav Mismeret (IL); Arvind RAMAN, Austin, TX (US); Mariusz ORIOL, Gdynia (PL); Nilanjan PALIT, Northborough, MA (US); Philip ABRAHAM, Rye, NY (US); Priyanka GANESH, Redmond, WA (US); Daniel G. CARTAGENA, Chandler, AZ (US); Mateusz DUCHALSKI, Bydgoszcz (PL)

(21) Appl. No.: 18/600,496

(22) Filed: Mar. 8, 2024

Related U.S. Application Data
(60) Provisional application No. 63/614,768, filed on Dec. 26, 2023.

(51) Int. Cl. G06F 12/0842; G06F 1/3206; G06F 1/3293; G06F 12/084

(52) U.S. Cl. CPC G06F 12/0842; G06F 1/3206; G06F 1/3293; G06F 12/084

(57) ABSTRACT

Examples described herein relate to at least one multi-core processor and a circuitry can determine and output energy usage of a process regardless of a core of the at least one multi-core processor that executes the process. The circuitry can determine the energy usage of the process based on cache operations and processor microoperations associated with the process. The energy usage of the process can be based on dynamic capacitance (Cdyn) levels and one or more of: temperature of the at least one multi-core processor, input voltage temperature to the at least one multi-core processor, and/or frequency of the at least one multi-core processor.

### RELATED APPLICATIONS

This application claims priority from U.S. Provisional Application No. 63/614,768, filed Dec. 26, 2023. The entire content of that application is incorporated by reference in its entirety.

### BACKGROUND

With the growth in computing capabilities in cloud computing (e.g., data centers and Edge), an increase in power consumption by cloud computing is occurring. Current industry products can measure energy usage at a hardware component level (e.g., a system on chip (SOC), memory, a network interface controller (NIC), or storage drive). Data centers and Edge devices can use renewable and non-renewable energy sources. Renewable, low carbon, or low greenhouse gas emission sources can include solar, wind, hydroelectric, or nuclear energy. Non-renewable energy sources, high carbon sources, or high greenhouse gas emission sources can include fossil fuel, coal, or gas burning energy. Carbon emissions can be measured in terms of CO₂ emissions in kilograms (kg) or other metrics.

### BRIEF DESCRIPTION OF THE DRAWINGS

FIG. 1 depicts an example system.

FIG. 2 depicts an example operation.

FIG. 3 depicts an example process.

FIG. 4 depicts an example processor.

FIG. 5 depicts an example system.

### DETAILED DESCRIPTION

An energy usage metric can be address and operand insensitive and can be determined by estimation to reduce a likelihood of side-channel attacks. The error difference between energy usage measurement and energy usage estimation can be low and can be an acceptable trade-off between energy measurement accuracy and security and maintaining confidentiality of energy data.

Datacenter and Edge operators monitor energy consumption of software and services to reduce their carbon footprint and reduce energy consumption, in general. In some cases, to identify and remediate software and services that contribute to the carbon footprint or to reduce energy consumption of software and services, it may be highly desirable for datacenter and Edge operators to monitor energy measurement at a thread, process, container, virtual machine (VM), application, or service level.

Various examples described herein can monitor energy utilization of a process (e.g., thread, VM, container, application, or others), irrespective of a processor that executes the process. In some examples, circuitry can track a number of operations of the processor(s) during performance of the process. The number of operations can be based on unique microoperations (uops) and microarchitectural events that are potentially multiplied by weights. Based on a change of a software thread executed by a processor, circuitry can output data that includes: the count of operations, microarchitectural events, processor operating voltage, processor operating frequency, and processor temperature with an associated process identifier (e.g., resource monitoring identifier (ID) (RMID) or process address space identifier (PASID)) that represents the software thread that was last running on the processor. For example, a PASID can be utilized that is based on Single Root Input Output Virtualization (SRIOV) (e.g., Single Root I/O Virtualization (SRIOV) and Sharing specification, version 1.1, published Jan. 20, 2010 by the Peripheral Component Interconnect (PCI) Special Interest Group (PCI-SIG)) or Intel® Scalable I/O Virtualization (SIOV) (e.g., Intel® Scalable I/O Virtualization Technical Specification, revision 1.0, June 2018).

A telemetry aggregator (e.g., microprocessor or other circuitry) can receive the data via a packet using an isolated network to reduce impact on the workload execution. The telemetry aggregator can determine an energy usage of the process based on the data. In some examples, the energy usage can be based on dynamic capacitance (Cdyn) of the processor(s) that perform the process. The telemetry aggregator can provide multiple logical views to different users by representing the data in data formats usable by datacenter operators. Telemetry consumers can include software agents (e.g., operating system (OS), Virtual Machine Manager (VMM), monitoring tools, orchestration tools, and software development tools). In addition, the telemetry can be accessed by end users (e.g., datacenter operators, system administrators, software developers). Based on the energy usage data, remedial actions can be performed such as causing execution of a future execution of the process on one or more processors that utilize less energy or permit continued execution of the process on previously utilized processor(s) or others.

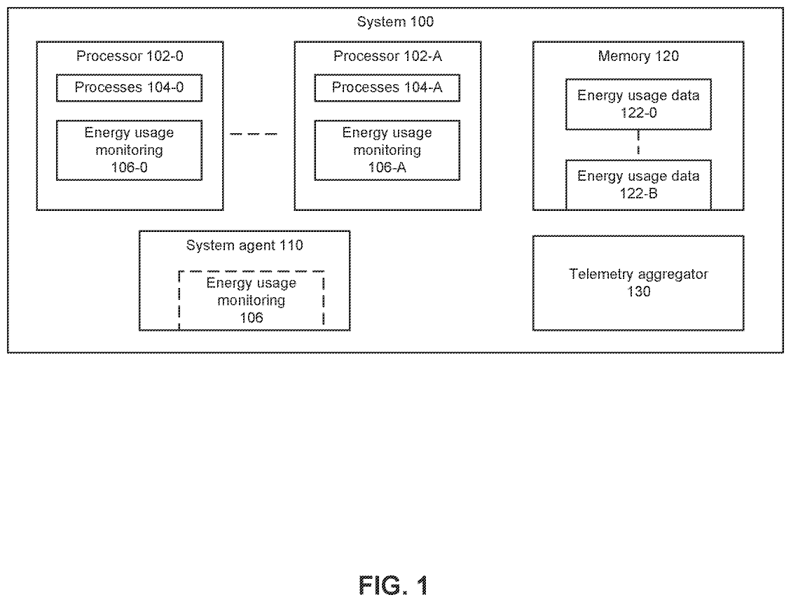

FIG. 1 depicts an example system. Examples can determine energy consumption of a process executing on multiple processors independent of the processor that executes the process. Processors 102-0 to 102-A, where A is an integer, can include one or more of: a graphics processing unit (GPU), central processing unit (CPU), CPU core, field programmable gate array (FPGA), an accelerator, application specific integrated circuit (ASIC), cache, memory, network interface device, or other instruction executing processor or fixed function circuitry. For example, an accelerator can perform one or more of: compression/decompression, encryption/decryption, matrix arithmetic, matrix multiplication, or other operations.

Processors 102-0 to 102-A can execute respective processes 104-0 to 104-A. Processes 104-0 to 104-A can include one or more of: an application, a microservice, virtual machine (VM), microVM, container, thread, or other virtualized execution environment.

A process can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. A process can perform video processing or media transcoding (e.g., changing the encoding of audio, image or video files).

Energy usage monitoring 106-0 to 106-A can capture activity data for respective processes 102-0 to 102-A executing on respective processors 102-0 to 102-A. Energy usage monitoring 106-0 can determine activity data for multiple processes executing on processor 102-0. Similarly, energy usage monitoring 106-A can determine activity data for multiple processes executing on processor 102-A, and so forth for energy usage monitoring 106-B and others. For example, one or more of energy usage monitoring 106-0 to 106-A can be implemented in a respective processor 102-0 to 102-A or outside of the processor 102-0 to 102-A.

System agent 110 can include or more of a memory controller, a shared cache (e.g., last level cache (LLC)), a cache coherency manager, arithmetic logic units, floating point units, core or processor interconnects, Caching/Home Agent (CHA), interface circuitry (e.g., fabric, memory, device), and/or bus or link controllers. System agent 110 can include circuitry that is to provide one or more of: direct memory access (DMA) engine connection, non-cached coherent master connection, data cache coherency between cores and arbitrate cache requests, or Advanced Microcontroller Bus Architecture (AMBA) capabilities. In some examples, system agent 110 can include circuitry to perform energy usage monitoring 106 for one or more process executing on one or more of processors 102-0 to 102-A.

In some examples, for a process identified to be retired, such at or after a context change to a different process, one or more of energy usage monitoring 106-0 to 106-A can track or count microoperations (uops) and track or count occurrences of microarchitectural events. Microoperations can represent an instruction broken down into hardware operations. A microoperation can include an elementary operation performed on data stored in one or more registers. Examples of microoperations are shift, count, clear, load, and other arithmetic operations (e.g., add, multiply, logical operations (e.g., AND, OR, XOR, or others)).

For example, when a thread starts on a processor 102-0, energy usage monitoring 106-0 can capture a count of microoperations and events that represent activity values on the processor that executes a process 104-0 even if process 104-0 is migrated for execution on a different processor (e.g., processor 102-1 or 102-2). An activity value can be based on a counter summing a number of microoperations and events performed by a processor and events over a time span. The counter value can be adjusted by a weighting, as described herein.

During a testing phase of a processor (e.g., one or more of processors 102-0 to 102-A), a weight for a known microoperation or event can be determined based on measuring energy usage for an execution of the known microoperation or event. A quantity of unique microoperations and/or microarchitectural events measured for execution of the process can be multiplied by a corresponding energy weight or weighting so that a count of microoperations and events more accurately reflect energy usage during performance of the process. The energy weight or weighting can be measured on the processor, as described herein. Energy weights can be unique of different events and operations. For example, energy weight or weighting values for events 0 to n are illustrated below.

| i | Event | Weighted value |
|---|---|---|
| 0 | Integer operation [128 bit] | 2.2 |
| 1 | Integer operation [256 bit] | 3.2 |
| 2 | Integer operation [512 bit] | 4.2 |
| 3 | Memory load/store [128 bit] | 1.3 |
| 4 | Memory load/store [256 bit] | 2.3 |
| 5 | Memory load/store [512 bit] | 3.3 |
| 6 | Fused multiply add (fma) [128 bit] | 4.4 |
| 7 | fma [256 bit] | 5.4 |
| 8 | fma [512 bit] | 6.4 |
| 9 | Floating point (FP) operation | 4.3 |
| . . . | | |
| 200 | Branch mispredict | 3.2 |
| 201 | Cache hit | 2.1 |
| 202 | Cache replacement | 3.0 |
| . . . | | |
| N | | |

Note that an integer or floating point operation can include add, multiply, multiply and add, logical OR, logical XOR, logical AND, or others. An integer (int) value format can include 8 bits, integer 16, integer 32, or an integer with number of bits that are multiples of 2. A format of floating point (FP) data can be FP8, FP16, FP32, FP64, or a floating point with number of bits that are multiples of 2. Accordingly, a sum of weighted values can represent an activity value of process 104-0 executed by one or more processors, or another process and the sum of weighted values can be stored in energy usage data 122-0. Similar operations can be performed for processes 104-1 to 104-A.

To pass a knowledge of specific workload identifier from operating system (OS) to a device (e.g., SoC, CPU, accelerator, or others), an OS or virtual machine monitor (VMM), executed by a processor, can send a notification of an identifier for a software thread (e.g., RMID or PASID) being scheduled for execution, at or after a context switch to a different thread. For example, the OS or VMM can write the RMID to a register or memory 120 (e.g., IA32_PQR_ASSOC register). For example, a processor-executed software or circuitry that manages cache and memory utilization (e.g., cache management technology) can assign an RMID or PASID to a process, regardless of how many processors the process runs on and can assign an RMID to a thread.

One or more of energy usage monitoring 106-0 to 106-A can provide respective energy usage data 122-0 to 122-B, where B is an integer and is equal to or more than A, in memory 120 with an associated process identifier via a side band interface to telemetry aggregator 130 or store energy usage data 122-0 to 122-B in memory 120. Telemetry aggregator 130 (e.g., a microcontroller in an SoC) can track activity values associated with different process identifiers (e.g., RMIDs or PASIDs), as described herein. Telemetry aggregator 130 can be positioned outside of a processor, server (e.g., system 100), or in another server connected via a network interface.

However, activity value data can be insensitive to processor voltage, processor frequency, processor leakage, processor temperature, and in-die variation. When a processor operates at a higher frequency, the processor can execute and retire more instructions per second, compared to when the processor operates at a lower frequency, which can result in higher Cdyn. Telemetry aggregator 130 can translate weighted activity value data for a process into Cdyn based on voltage, frequency, and/or temperature of the processor(s) that performed the process. A linear or non-linear regression of activity data and calculated energy utilization (e.g., power calculated by Ansys PowerArtist™) can be performed. A pre-determined set of trace lists can be performed by processors and event counts and average current level collected. Based on the event counts, energy utilization can be calculated from the current level and linear regression performed using event counts and average energy utilization.

In some examples, memory 120 can store energy usage data 122-0 to 122-B. Energy usage data 122-0 to 122-B can indicate, per-process identifier, a count of microoperations and weighted events. In some examples, memory 120 can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory 120 can include static random access memory (SRAM) memory technology or memory technology consistent with high bandwidth memory (HBM), or double data rate (DDR), among others.

While examples are described with respect to energy usage by a processor, energy usage monitoring 106-0 to 106-A can capture energy usage of an accelerator, network interface device, PCIe device, memory device, cache, or uncore, such as where a core offloads operations to an accelerator, network interface device, PCIe device, memory device, cache, or uncore. Usage of an accelerator, network interface device, PCIe device, memory device, cache, or uncore, outside of a core, by software can be based on usage proportional to software usage of cores (e.g., different RMID values) or based on input output (IO) bandwidth or memory bandwidth usage allocated to software (e.g., different RMID values).

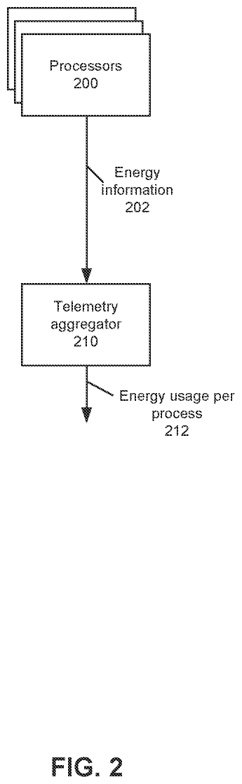

FIG. 2 depicts an example operation. Processors 200 and telemetry aggregator 210 can be implemented in a system on chip (SoC) and communicatively coupled by an SoC fabric. In some examples, one or more changes of an RMID associated with an executed thread can cause reporting by processors 200 of energy information 202 to telemetry aggregator 210. In some examples, processors 200 can periodically report energy information 202 to telemetry aggregator 210 to ensure telemetry is not dated in the midst of long-running RMID residencies. Energy information 202 can include one or more of: process identifier (e.g., RMID or PASID), operation count, activity count (e.g., sum of weighted operation counts), voltage input to processor, frequency of operation of the processor, temperature of the processor, or others.

In some examples, processors 200 can provide energy information 202 in one or more packets to telemetry aggregator 210. Processors 200 can utilize circuitry that provides inputs to telemetry aggregator 210 for calculating energy and transmitting energy values in packets via an SoC fabric. An SoC fabric could include a general purpose fabric shared with a main band traffic or a dedicated internal isolated telemetry fabric

Based on energy information 202, telemetry aggregator 210 can determine energy usage by a process. Telemetry aggregator 210 can calculate, transform, aggregate, and expose telemetry to software agents. Telemetry aggregator 210 can be implemented as firmware running on a microcontroller. In some examples, telemetry aggregator 210 can accumulate per-RMID activity, where per-RMID accumulated activity can be calculated by multiplying Cdyn by current duration of RMID residency or relative fraction of time that one or more processes associated with a particular RMID value execute. In some examples, Cdyn can represent energy use of a process irrespective of voltage, frequency, and/or temperature of the processor that executes the process. The resulting cumulative activity can be exposed to software agents (e.g., orchestrator, VMM, OS, administrator, activity log). The resulting cumulative activity can be used to analyze energy use of a process in a manner insensitive to voltage, frequency, temperature, in-die variation, or others.

However, on different processors, for the same activity, the energy usage can be different for a different processor voltage, processor frequency, and processor temperature. Telemetry aggregator 210 can calculate energy utilization to perform a process based at least on Cdyn and leakage. For example, energy utilization can be based on Cdyn*Voltage²*Frequency+Leakage.

In some examples, core leakage can be based on supplied voltage, core temperature, and other silicon characteristics. In some examples, core leakage can be determined based on:

$${I}_{leakage} = {IA}_{{LEAK}_{VAR}} * ( ( CC {6}_{off / on} * {IA\_LEAK}_{core} * {FACTOR}_{TMUL} ) [ per\_core ] + {MLC\_LEAK}_{mlc} ) * {e}^{a * dV + b * dT - c * dV * dT}$$

where:
a can represent a constant voltage factor from a configuration (“IA_LEAK_EQ_V”);
b can represent a temperature factor from a configuration (“IA_LEAK_EQ_T”);
c can represent a temperature*voltage factor;
dV can represent delta voltage (V−IA_REFERENCE_VOLTAGE) that varies according to input voltage; and
dT can represent delta temperature (T−IA_REFERENCE_TEMPERATURE) that varies according to core's temperature.

Telemetry aggregator 210 can determine processor power leakage based on detected power loss from testing of power consumption of a processor compared to power supplied (e.g., power supplied−power consumed). This energy utilization value can be exposed to software agents (e.g., orchestrator, VMM, OS, administrator, activity log) as per-RMID energy.

In some examples, telemetry aggregator 210 can be implemented as part of a cache management technology or other circuitry that allocates shared hardware resources such as Last Level Cache (LLC) and Memory Bandwidth to applications. RDT can perform at least Memory Bandwidth Monitoring (MBM), Memory Bandwidth Allocation (MBA), Cache Monitoring Technology (CMT), Cache Allocation Technology (CAT) and Code and Data Prioritization (CDP). In a similar manner, AMD Platform Quality of Service (AMD QoS) provides allocation of at least some of the same resources to applications. Similar technologies can be used with other processor designers or manufacturers including ARM®, Qualcomm®, IBM®, Nvidia®, Broadcom®, Texas Instruments®, among others. For example, an example of cache management technology includes Intel® Resource Director Technology, ARM Memory Partitioning and Monitoring (MPAM), or cache or power management technologies for RISC-V.

For example, MBM can provide event reporting of L3 cache misses per application. Reporting local memory bandwidth can include a report of bandwidth of a thread accessing memory associated with the local socket. In a dual socket system, the remote memory bandwidth can include a report the bandwidth of a thread accessing the remote socket. For example, MBM can provide monitoring of multiple virtual machines (VMs), containers, or applications independently, which can provide memory bandwidth monitoring for running threads simultaneously.

For example, MBA can provide control over memory bandwidth available to workloads, enabling new levels of interference mitigation and bandwidth shaping for “noisy neighbors” present on the system. Memory bandwidth can represent a rate at which data can be read from or stored into a memory device or storage device by a processor.

For example, CMT can provide monitoring of last-level cache (LLC) utilization by individual threads, applications, VMs, or containers. CMT can enable tracking of the L3 cache occupancy, enabling detailed profiling and tracking of threads, applications, or virtual machines. CMT can enable resource-aware scheduling decisions, aid in “noisy neighbor” detection and assist with performance debugging.

For example, CAT can provide software-guided redistribution of cache capacity, enabling important data center requesters to benefit from improved cache capacity and reduced cache contention. CAT can provide an interface for the OS or hypervisor to group requesters into classes of service (CLOS) and indicate the amount of last-level cache available to a CLOS. These interfaces can be based on MSRs (Model-Specific Registers). CAT may be used to enhance runtime determinism and prioritize important requesters such as virtual switches or Data Plane Development Kit (DPDK) packet processing apps from resource contention across various priority classes of workloads. CAT can allow an operating system (OS), hypervisor, or virtual machine manager (VMM) to control allocation of a central processing units (CPU) shared LLC.

For example, CDP can provide separate control over code and data placement in a last-level (L3) cache.

In some examples, telemetry aggregator 210 can be implemented as part of a management controller. A management controller can perform management and monitoring capabilities for system administrators to monitor operation at least system 100 (FIG. 1) (and devices connected thereto) using channels, including channels that can communicate data (e.g., in-band channels) and out-of-band channels. Out-of-band channels can include packet flows or transmission media that communicate metadata and telemetry and may not communicate data.

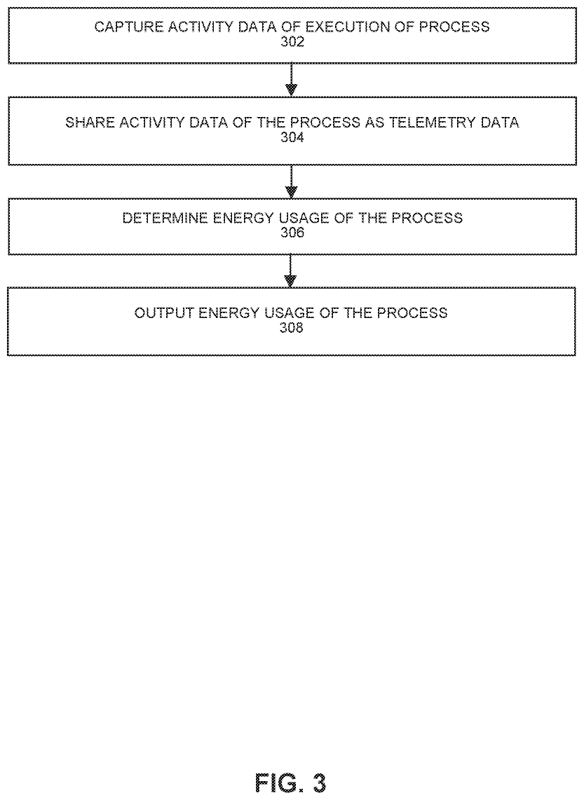

FIG. 3 depicts an example process. The process can be performed by a processor-executed software or circuitry. At 302, activity values for operations performed during operation of a process by one or more processors. For example, activity values can represent a sum of microoperations and events performed by the one or more processors during performance of the process. In some examples, the microoperations and events can be weighted based on test data indicating energy consumption for activity values.

At 304, telemetry data associated with the process can be provided to a telemetry aggregator. For example, telemetry data can include one or more of: process identifier (e.g., RMID or PASID), sum of weighted activity values, voltage of processor(s) that performed the process, frequency of operation of the processor(s) that performed the process, temperature of the processor(s) that performed the process, or others. In some examples, activity values can be provided to the telemetry aggregator based on a change from execution of the process to a second process, such as a context change or completion of the process.

At 306, energy usage of the process can be determined. In some examples, energy usage can be represented by an activity value and independent from frequency of operation of the processor(s) that performed the process and temperature of the processor(s) that performed the process. In some examples, energy usage can be based on operating conditions of processor(s) that performed the process and calculated based on frequency of operation of the processor(s) that performed the process, and/or temperature of the processor(s) that performed the process.

At 308, the energy usage of the process can be made available for access. For example, the per-process energy usage data can be made available to an orchestrator, administrator, operating system (OS), virtual machine manager (VMM), or others. For example, carbon (CO₂) emission intensity (gC02eq/kWh) can be utilized as a metric to determine energy impact (e.g., renewable and non-renewable). Measured energy, which can be represented in kWh, can be used to determine corresponding carbon emissions from non-renewable sources of energy. Based on the energy usage, a determination of renewable and non-renewable energy utilization by the process can be adjusted.

For example, execution of the process can utilize renewable and non-renewable energy and the process can be migrated for execution on a different processor or processors to reduce non-renewable energy usage or energy usage in general. For example, examples can identify highest power-using services for energy-aware orchestration decisions, indicate energy cost of software for software redesign or deployment changes, or predict processor lifetime or failure as a CPU aging sensor.

For example, based on energy use data, an operator may time shift the workload to run at a different time of day when the energy source is based on a higher percentage of renewable energy. For example, based on energy use data, a tenant might be charged a financial penalty for exceeding a power budget. For example, based on energy use data, the processor might be instructed to slow down the execution of a specific workload to reduce both power and performance.

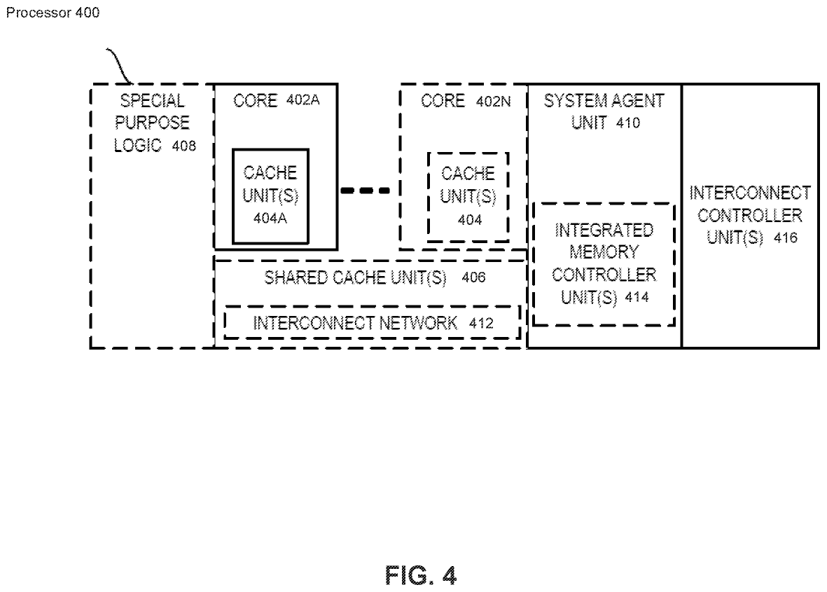

FIG. 4 illustrates a block diagram of embodiments of a processor 400 that may have more than one core, may have an integrated memory controller, and may have integrated graphics. In some examples, energy usage of a processor can be determined, as described herein. The solid lined boxes illustrate a processor 400 with a single core 402A, a system agent 410, a set of one or more interconnect controller units circuitry 416, while the optional addition of the dashed lined boxes illustrates an alternative processor 400 with multiple cores 402(A)-(N), a set of one or more integrated memory controller unit(s) circuitry 414 in the system agent unit circuitry 410, and special purpose logic 408, as well as a set of one or more interconnect controller units circuitry 416.

Thus, different implementations of the processor 400 may include: 1) a CPU with the special purpose logic 408 being integrated graphics and/or scientific (throughput) logic (which may include one or more cores, not shown), and the cores 402(A)-(N) being one or more general purpose cores (e.g., general purpose in-order cores, general purpose out-of-order cores, or a combination of the two); 4) a coprocessor with the cores 402(A)-(N) being a large number of special purpose cores intended primarily for graphics and/or scientific (throughput); and 3) a coprocessor with the cores 402(A)-(N) being a large number of general purpose in-order cores. Thus, the processor 400 may be a general-purpose processor, coprocessor or special-purpose processor, such as, for example, a network processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 400 may be a part of and/or may be implemented on one or more substrates using any of a number of process technologies, such as, for example, BiCMOS, CMOS, or NMOS.

A memory hierarchy includes one or more levels of cache unit(s) circuitry 404(A)-(N) within the cores 402(A)-(N), a set of one or more shared cache units circuitry 406, and external memory (not shown) coupled to the set of integrated memory controller units circuitry 414. The set of one or more shared cache units circuitry 406 may include one or more mid-level caches, such as level 4 (L2), level 3 (L3), level 4 (L4), or other levels of cache, such as a last level cache (LLC), and/or combinations thereof. While in some embodiments ring-based interconnect network circuitry 412 interconnects the special purpose logic 408 (e.g., integrated graphics logic), the set of shared cache units circuitry 406, and the system agent unit circuitry 410, alternative embodiments use any number of well-known techniques for interconnecting such units. In some embodiments, coherency is maintained between one or more of the shared cache units circuitry 406 and cores 402(A)-(N).

In some embodiments, one or more of the cores 402(A)-(N) are capable of multi-threading. System agent unit circuitry 410 includes those components coordinating and operating cores 402(A)-(N). The system agent unit circuitry 410 may include, for example, power control unit (PCU) circuitry and/or display unit circuitry (not shown). The PCU may include logic and components needed for regulating the power state of the cores 402(A)-(N) and/or the special purpose logic 408 (e.g., integrated graphics logic). The display unit circuitry is for driving one or more externally connected displays.

Cores 402(A)-(N) may be homogenous or heterogeneous in terms of architecture instruction set. For example, two or more of the cores 402(A)-(N) may be capable of executing the same instruction set, while other cores may be capable of executing only a subset of that instruction set or a different instruction set.

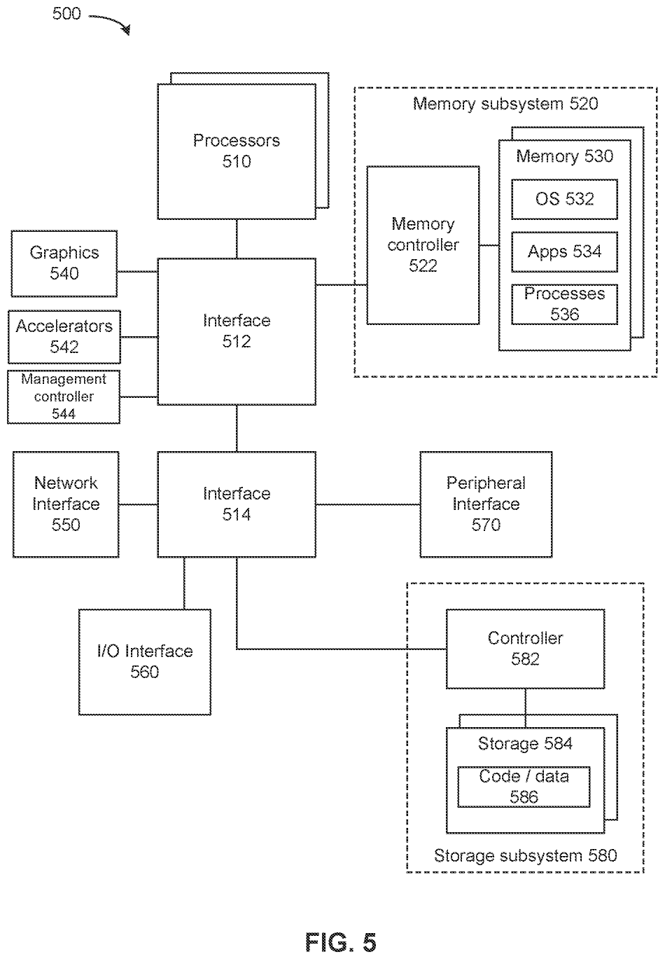

FIG. 5 depicts a system. In some examples, circuitry can determine energy usage of a process executed by one or more devices (e.g., processor 510, accelerators 542, graphics 540, network interface 550, or other circuitry), as described herein. System 500 includes processor 510, which provides processing, operation management, and execution of instructions for system 500. Processor 510 can include any type of microprocessor, central processing unit (CPU), graphics processing unit (GPU), xPU, processing core, or other processing hardware to provide processing for system 500, or a combination of processors. An xPU can include one or more of: a CPU, a graphics processing unit (GPU), general purpose GPU (GPGPU), and/or other processing units (e.g., accelerators or programmable or fixed function FPGAs). Processor 510 can control the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a display that provides an output to a user. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, a packet processing device or a network interface device 550 can refer to one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized Radio Access Networks (vRANs), cryptographic operations, compression/decompression, and so forth).

In some examples, operations of management controller 544 or other circuitry can be configured to determine energy utilization per-process identifier, as described herein.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), RoCEv2, Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 500 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes an apparatus comprising: at least one multi-core processor and a circuitry to determine and output energy usage of a process regardless of a core of the at least one multi-core processor that executes the process, wherein the circuitry is to determine the energy usage of the process based on cache operations and processor microoperations associated with the process.

Example 2 includes one or more examples, wherein operations of the process comprise one or more of: events, microoperations, or instruction executions.

Example 3 includes one or more examples, wherein the energy usage of the process is based on dynamic capacitance (Cdyn) levels and one or more of: temperature of the at least one multi-core processor, input voltage temperature to the at least one multi-core processor, and/or frequency of the at least one multi-core processor.

Example 4 includes one or more examples, wherein the energy usage of the process is based on weighted values of operations of the process.

Example 5 includes one or more examples, wherein the circuitry is to determine energy usage of the process based on a change from execution of the process to execution of a second process.

Example 6 includes one or more examples, wherein the energy usage of the process is associated with a process identifier.

Example 7 includes one or more examples, wherein the process comprises one or more of: microservice, virtual machine (VM), microVM, application, container, process, thread, or virtualized execution environment.

Example 8 includes one or more examples, wherein the at least one multi-core processor includes one or more of: a central processing unit (CPU), accelerator, graphics processing unit (GPU), application specific integrated circuitry (ASIC), a field programmable gate array (FPGA), a network interface device, or a system agent.

Example 9 includes one or more examples, and includes a method that includes: determining energy usage of a process regardless of a core of at least one multi-core processor that executes the process, wherein the determining energy usage of the process is based on cache operations and processor microoperations associated with the process and outputting the determined energy usage.

Example 10 includes one or more examples, wherein operations of the process comprise one or more of: events, microoperations, or instruction executions.

Example 11 includes one or more examples, wherein the energy usage of the process is based on dynamic capacitance (Cdyn) levels and one or more of: temperature of the at least one multi-core processor, input voltage temperature to the at least one multi-core processor, and/or frequency of the at least one multi-core processor.

Example 12 includes one or more examples, wherein the energy usage of the process is based on weighted values of operations of the process.

Example 13 includes one or more examples, wherein the determining energy usage of a process regardless of a core of at least one multi-core processor that executes the process is based on a change from execution of the process to execution of a second process.

Example 14 includes one or more examples, wherein the energy usage of the process is associated with a process identifier.

Example 15 includes one or more examples, wherein the at least one multi-core processor includes one or more of: a central processing unit (CPU), accelerator, graphics processing unit (GPU), application specific integrated circuitry (ASIC), a field programmable gate array (FPGA), a network interface device, or a system agent.

Example 16 includes one or more examples, and includes at least one non-transitory computer-readable medium, comprising instructions stored thereon, that if executed by one or more processors, cause the one or more processors to: determine and output energy usage of a process regardless of a processor of at least two processors that executes the process, wherein the energy usage of the process is based on operations of the process.

Example 17 includes one or more examples, wherein the operations of the process comprise one or more of: events, microoperations, or instructions executions.

Example 18 includes one or more examples, wherein the operations of the process are based on dynamic capacitance (Cdyn) levels and one or more of: temperature of the at least two processors, input voltage temperature to the at least two processors, and/or frequency of the at least two processors.

Example 19 includes one or more examples, wherein the determine energy usage of the process is based on a change from execution of the process to execution of a second process.

Example 20 includes one or more examples, comprising instructions stored thereon, that if executed by the one or more processors, cause the one or more processors to: determine energy usage of a second process associated with a same process identifier as that of the process and output energy usage aggregate energy usage associated with the process and the second process and associate the aggregate energy with the process identifier.

1. An apparatus comprising:
at least one multi-core processor and
a circuitry to determine and output energy usage of a process regardless of a core of the at least one multi-core processor that executes the process, wherein the circuitry is to determine the energy usage of the process based on cache operations and processor microoperations associated with the process.

2. The apparatus of claim 1, wherein operations of the process comprise one or more of: events, microoperations, or instruction executions.

3. The apparatus of claim 1, wherein the energy usage of the process is based on dynamic capacitance (Cdyn) levels and one or more of: temperature of the at least one multi-core processor, input voltage temperature to the at least one multi-core processor, and/or frequency of the at least one multi-core processor.

4. The apparatus of claim 1, wherein the energy usage of the process is based on weighted values of operations of the process.

5. The apparatus of claim 1, wherein the circuitry is to determine energy usage of the process based on a change from execution of the process to execution of a second process.

6. The apparatus of claim 1, wherein the energy usage of the process is associated with a process identifier.

7. The apparatus of claim 1, wherein the process comprises one or more of: microservice, virtual machine (VM), microVM, application, container, process, thread, or virtualized execution environment.

8. The apparatus of claim 1, wherein the at least one multi-core processor includes one or more of: a central processing unit (CPU), accelerator, graphics processing unit (GPU), application specific integrated circuitry (ASIC), a field programmable gate array (FPGA), a network interface device, or a system agent.

9. A method comprising:
determining energy usage of a process regardless of a core of at least one multi-core processor that executes the process, wherein the determining energy usage of the process is based on cache operations and processor microoperations associated with the process and
outputting the determined energy usage.

10. The method of claim 9, wherein operations of the process comprise one or more of: events, microoperations, or instruction executions.

11. The method of claim 9, wherein the energy usage of the process is based on dynamic capacitance (Cdyn) levels and one or more of: temperature of the at least one multi-core processor, input voltage temperature to the at least one multi-core processor, and/or frequency of the at least one multi-core processor.

12. The method of claim 9, wherein the energy usage of the process is based on weighted values of operations of the process.

13. The method of claim 9, wherein the determining energy usage of a process regardless of a core of at least one multi-core processor that executes the process is based on a change from execution of the process to execution of a second process.

14. The method of claim 9, wherein the energy usage of the process is associated with a process identifier.

15. The method of claim 9, wherein the at least one multi-core processor includes one or more of: a central processing unit (CPU), accelerator, graphics processing unit (GPU), application specific integrated circuitry (ASIC), a field programmable gate array (FPGA), a network interface device, or a system agent.

16. At least one non-transitory computer-readable medium, comprising instructions stored thereon, that if executed by one or more processors, cause the one or more processors to:
determine and output energy usage of a process regardless of a processor of at least two processors that executes the process, wherein the energy usage of the process is based on operations of the process.

17. The computer-readable medium of claim 16, wherein the operations of the process comprise one or more of: events, microoperations, or instructions executions.

18. The computer-readable medium of claim 16, wherein the operations of the process are based on dynamic capacitance (Cdyn) levels and one or more of: temperature of the at least two processors, input voltage temperature to the at least two processors, and/or frequency of the at least two processors.

19. The computer-readable medium of claim 16, wherein the determine energy usage of the process is based on a change from execution of the process to execution of a second process.

20. The computer-readable medium of claim 16, comprising instructions stored thereon, that if executed by the one or more processors, cause the one or more processors to:
determine energy usage of a second process associated with a same process identifier as that of the process and
output energy usage aggregate energy usage associated with the process and the second process and associate the aggregate energy with the process identifier.
